(19) United States
(12) Patent Application Publication
(10) Pub. No.: US 2016/0036187 A1
(43) Pub. Date: Feb. 4, 2016

(54) MANUFACTURING METHOD OF BUS BAR UNIT

(71) Applicant: KAYABA INDUSTRY CO., LTD., Tokyo (JP)

(72) Inventors: Nobuji HOUZUMI, Kanagawa (JP); Tarou MATSUMAE, Kanagawa (JP); Yoshiteru KUROKAWA, Kanagawa (JP); Suguru SAKAMOTO, Kanagawa (JP); Tohru TAKIMOTO, Fukui (JP); Shingo YAMADA, Fukui (JP)

(73) Assignee: KAYABA INDUSTRY CO., LTD., Tokyo (JP)

(21) Appl. No.: 14/772,222

(22) PCT Filed: Jan. 27, 2014
(86) PCT No.: PCT/JP2014/051644

§ 371 Date: Sep. 2, 2015

(30) Foreign Application Priority Data
Mar. 8, 2013 (JP) 2013-047245

(51) Int. Cl. H01R 43/16; B29C 45/14

(52) U.S. Cl. CPC H01R 43/16; B29C 45/14639

(57) ABSTRACT

A manufacturing method of a bus bar unit includes: a primary setting step of disposing a part of a plurality of bus bars into a first mold; a primary molding step of performing an insert molding by injecting the insulating resin material into the first mold, so as to form a primary molded member having a step part; a secondary setting step of disposing the primary molded member and a remaining bus bar of the plurality of bus bars into a second mold; and a secondary molding step of performing the insert molding by injecting the insulating resin material into the second mold, so as to form the bus bar unit. In the secondary setting step, the primary molded member and the remaining bus bar of the plurality of bus bars are arranged in the second mold in such a manner that at least one of an outer periphery and an inner periphery of the remaining bus bar abuts against the step part of the primary molded member.

### TECHNICAL FIELD

The present invention relates to a manufacturing method of a bus bar unit that is connected to windings of a motor, a power generator or the like, and that supplies a current to the windings.

### BACKGROUND ART

It is well known that a bus bar unit is employed in a stator of a motor and the like so as to supply a current from external terminal parts to windings of respective coils.

JP2006-101614A discloses a technique that forms a plurality of bus bars and an insulating resin by insert molding, the plurality of bus bars supply a current to respective windings of a stator, and the insulating resin keeps the bus bars with spaces therebetween in the axial direction of the stator.

A plurality of positioning holes are formed in the bus bars. At the time of the insert molding, support members (pins) that are formed on a mold are inserted into the positioning holes of the bus bars, so as to define the positions of the bus bars with respect to the mold.

### SUMMARY OF INVENTION

In the above-described conventional bus bar unit, a large force is applied to the respective bus bars due to a pressure of the resin injected into the mold, and hence it is difficult to secure positional accuracy of the respective bus bars.

It is an object of the present invention to provide a manufacturing method of the bus bar unit capable of securing the positional accuracy of the bus bars at the time of the insert molding.

According to one aspect of the present invention, a manufacturing method of a bus bar unit for performing insert molding of a plurality of bus bars by using an insulating resin material is provided, the manufacturing method of the bas bar includes: a primary setting step of disposing a part of the plurality of bus bars into a first mold; a primary molding step of performing the insert molding by injecting the insulating resin material into the first mold, so as to form a primary molded member having a step part; a secondary setting step of stacking and disposing the primary molded member and a remaining bus bar of the plurality of bus bars into a second mold; and a secondary molded step of performing the insert molding by injecting the insulating resin material into the second mold, so as to form the bus bar unit. In the secondary setting step, the primary molded member and the remaining bus bar of the plurality of bus bars are arranged in the second mold in such a manner that at least one of an outer periphery and an inner periphery of the remaining bus bar abuts against the step part of the primary molded member.

### BRIEF DESCRIPTION OF DRAWINGS

FIG. 1 is a structure diagram of a stator that forms a three phase AC motor;

FIG. 2 is a perspective view illustrating a bus bar unit;

FIG. 3 is a perspective view illustrating first to fourth bus bars;

FIG. 4 is a front view illustrating the second bus bar;

FIG. 5 is a side view illustrating the second bus bar;

FIG. 6 is a front view illustrating the first bus bar;

FIG. 7 is a side view illustrating the first bus bar;

FIG. 8 is a front view illustrating the fourth bus bar;

FIG. 9 is a side view illustrating the fourth bus bar;

FIG. 10 is a front view illustrating the third bus bar;

FIG. 11 is a side view illustrating the third bus bar;

FIG. 12 is a perspective view illustrating the first to fourth bus bars that are stacked;

FIG. 13A is a schematic view for explaining a primary setting step;

FIG. 13B is a schematic view for explaining a primary molding step;

FIG. 14 is a perspective view illustrating a primary molded member (forward direction);

FIG. 15 is a perspective view illustrating the state in which the respective bus bars are stacked on the primary molded member;

FIG. 16 is a front view illustrating the state in which the respective bus bars are stacked on the primary molded member;

FIG. 17 is a perspective view illustrating a primary molded member (backward direction);

FIG. 18 is a perspective view illustrating the state in which the respective bus bars are stacked on the primary molded member;

FIG. 19 is a rear view illustrating the state in which the respective bus bars are stacked on the primary molded member;

FIG. 20A is a schematic view for explaining a secondary setting step; and

FIG. 20B is a schematic view for explaining a secondary molding step.

### DESCRIPTION OF EMBODIMENTS

With reference to the drawings, an embodiment of the present invention will be described.

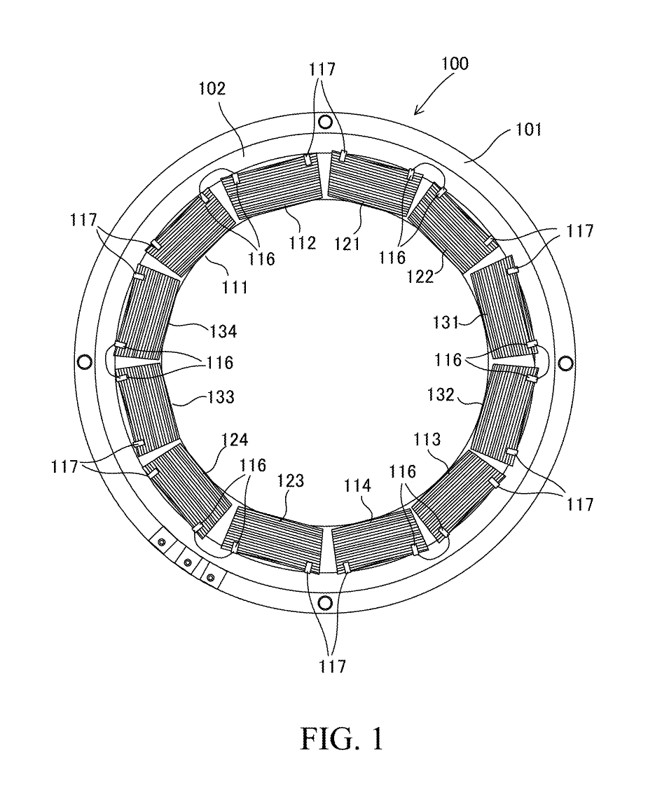

FIG. 1 is a structure diagram illustrating a stator 100 that forms a three phase AC motor.

A plurality of teeth, which are not illustrated, are formed on an annular-shaped stator core 102 that is held in a housing 101 in such a manner that the teeth project toward the inner periphery side. Copper wires are wound around the teeth to form coils 111 to 114, 121 to 124, and 131 to 134.

On the stator core 102, twelve coils in total, that is, U-phase coils 111 to 114, V-phase coils 121 to 124, and W-phase coils 131 to 134 are disposed annularly along the circumferential direction of the stator 100.

A first U-phase coil 111 and an adjacent second U-phase coil 112 are arranged opposingly to a third U-phase coil 113 and an adjacent fourth U-phase coil 114. Further, a first V-phase coil 121 and an adjacent second V-phase coil 122 are arranged opposingly to a third V-phase coil 123 and an adjacent fourth V-phase coil 124. Furthermore, a first W-phase coil 131 and an adjacent second W-phase coil 132 are arranged opposingly to a third W-phase coil 133 and an adjacent fourth W-phase coil 134.

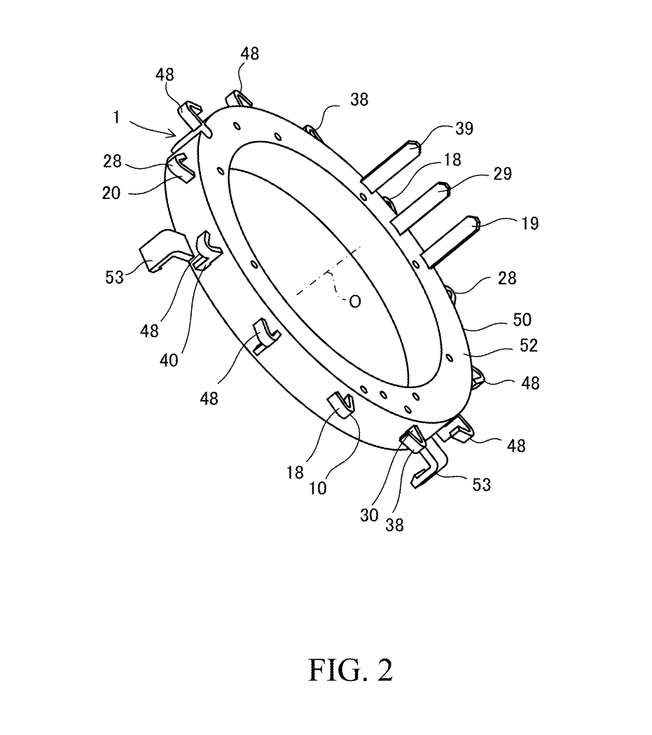

A bus bar unit 1 supplies a current, supplied from a not-illustrated power source, to the U-phase coils 111 to 114, the V-phase coils 121 to 124, and the W-phase coils 131 to 134, via a U-phase terminal 19, a V-phase terminal 29, and a W-phase terminal 39 (see FIG. 2) as external terminals. The coils of the respective phases 111 to 114, 121 to 124 and 131 to 134 are connected to the bus bar unit 1 via winding terminals 117 of the coils of the respective phases 111 to 114, 121 to 124, and 131 to 134. Moreover, the adjacent coils of the respective phases are connected to each other via winding terminals 116.

One ends of the first U-phase coil 111 and the fourth U-phase coil 114 are connected to the U-phase terminal 19 via a bus bar 10. The other ends of the first U-phase coil 111 and the fourth U-phase coil 114 are connected to one ends of the second U-phase coil 112 and the third U-phase coil 113. The other ends of the second U-phase coil 112 and the third U-phase coil 113 are connected to a neutral point via a neutral point bus bar 40.

The first U-phase coil 111 and the second U-phase coil 112 are connected to each other in series. The third U-phase coil 113 and the fourth U-phase coil 114 are connected to each other in series. Further, the first U-phase coil 111 and the second U-phase coil 112 are connected in parallel to the third U-phase coil 113 and the fourth U-phase coil 114, between the U-phase terminal 19 and the neutral point. In other words, the U-phase coils 111 to 114 have the two series/two parallel connection.

Similarly, one ends of the first V-phase coil 121 and the fourth V-phase coil 124 are connected to the V-phase terminal 29 via a bus bar 20. The other ends of the first V-phase coil 121 and the fourth V-phase coil 124 are connected to one ends of the second V-phase coil 122 and the third V-phase coil 123. The other ends of the second V-phase coil 122 and the third V-phase coil 123 are connected to the neutral point via the neutral point bus bar 40.

Similarly, one ends of the first W-phase coil 131 and the fourth W-phase coil 134 are connected to the W-phase terminal 39 via a bus bar 30. The other ends of the first W-phase coil 131 and the fourth W-phase coil 134 are connected to one ends of the second W-phase coil 132 and the third W-phase coil 133. The other ends of the second W-phase coil 132 and the third W-phase coil 133 are connected to the neutral point via the neutral point bus bar 40.

The U-phase terminal 19, the V-phase terminal 29, and the W-phase terminal 39 of the bus bar unit 1 are connected to an external wiring that is connected to a not-illustrated power source, and electric power is supplied from the external wiring. Meanwhile, potentials of the respective coils 112, 113, 122, 123, 132, and 133 that are connected to the neutral point are brought to the same potential via the neutral point bus bar 40.

FIG. 2 is a perspective view illustrating the bus bar unit 1.

An axis O is the center line of the bus bar unit 1 and the stator 100. In the following explanation, the “axial direction” means the direction along which the axis O extends, the “radial direction” means the radiation direction about the axis O, and the “circumferential direction” means the direction around the axis O.

The bus bar unit 1 is provided concentrically with the stator 100, about the axis O, at the end of the axial direction of the stator 100. The stator 100 is arranged on the lower side of the bus bar unit 1 in FIG. 2. The bus bar unit 1 is formed by the bus bars 10, 20, and 30 that correspond to the respective phases, the neutral point bus bar 40 that electrically connects the neutral point, and an insulating resin body 50 that receives all the bus bars 10, 20, 30, and 40, and that keeps the bus bars 10, 20, 30, and 40 at predetermined positions while electrically insulating the bus bars 10, 20, 30, and 40.

The respective bus bars 10, 20, 30, and 40 and the insulating resin body 50 are integrally molded by insert molding, for example. A plurality of arms 53, projecting from the outer periphery of the insulating resin body 50, engage with engagement parts (not illustrated) on the outer periphery of the stator 100, so as to fix the insulating resin body 50 to the stator 100.

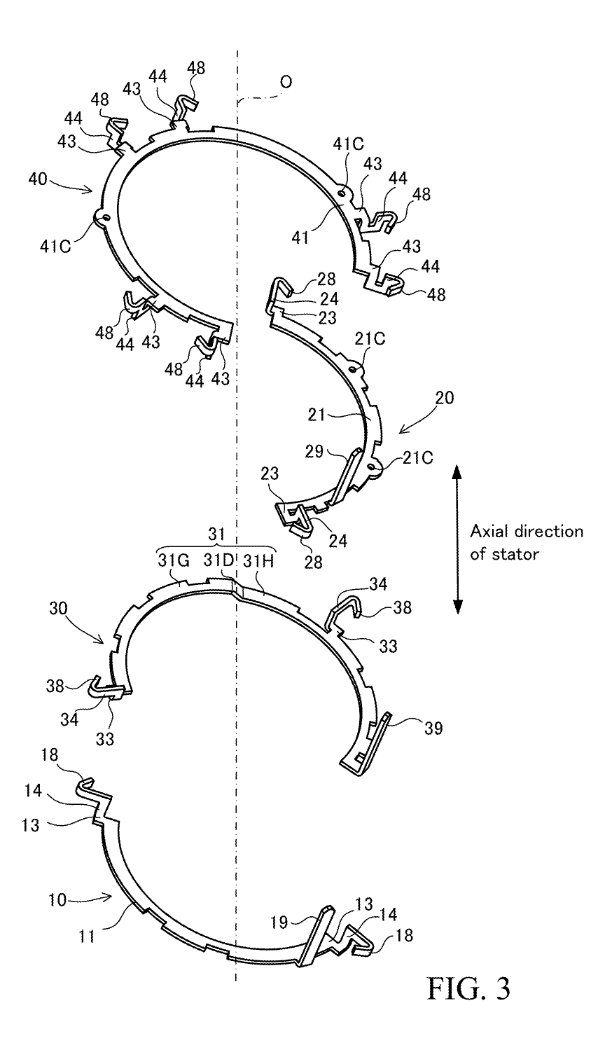

FIG. 3 is a perspective view illustrating the first to fourth bus bars 20, 40, 30, and 10.

The bus bar unit 1 is provided with the fourth bus bar 10 that is connected to the U-phase coils 111 and 114, the first bus bar 20 that is connected to the V-phase coils 121 and 124, the third bus bar 30 that is connected to the W-phase coils 131 and 134, and the second neutral point bus bar 40 that is connected to the U-phase coils 112 and 113, the V-phase coils 122 and 123, and the W-phase coils 132 and 133.

The first to fourth bus bars 20, 40, 30, and 10 respectively include main body parts 21, 41, 31, and 11 that are extended along the circumferential direction in such a manner that the plate thickness direction agrees with the axial direction, a plurality of projection parts 23, 43, 33, and 13 that project from the outer peripheries of the main body parts 21, 41, 31, and 11 to the outer side of the radial direction, extension parts 24, 44, 34, and 14 that are bent from the projection parts 23, 43, 33, and 13 and that are extended in the axial direction and the radial direction, and connection parts 28, 48, 38, and 18 that are provided at the tips of the extension direction of the extension parts 24, 44, 34, and 14 and that are connected to the winding terminals 117 of the coils of the respective phases 111 to 114, 121 to 124, and 131 to 134.

After a flat conductive material is punched to predetermined shapes, the extension parts 24, 44, 34, and 14 are bent from the projection parts 23, 43, 33, and 13, and the connection parts 28, 48, 38, and 18 are bent from the extension parts 24, 44, 34, and 14, so as to form the first to fourth bus bars 20, 40, 30, and 10.

Punching widths of the extension parts 24, 44, 34, and 14 are set to be equal to or greater than punching widths of the projection parts 23, 43, 33, and 13, so that the sufficient cross-sectional area of the conductive material can be secured.

Each of the main body parts 21, 41, 31, and 11 is formed to have an arc shape that is extended along the circumferential direction in such a manner that the plate thickness direction agrees with the axial direction. In other words, the thicknesses in the axial direction of the main body parts 21, 41, 31, and 11 are the plate thicknesses of the conductive material, and the widths in the radial direction are the punching widths of the conductive material.

The fourth bus bar 10, corresponding to the U-phase, is provided with the U-phase terminal 19 that is extended in the axial direction from the main body part 11 to the outside of the insulating resin body 50, and that is connected to the external wiring. Similarly, the first bus bar 20, corresponding to the V-phase, is provided with the V-phase terminal 29. Similarly, the third bus bar 30, corresponding to the W-phase, is provided with the W-phase terminal 39. The bus bar unit 1 distributes a current, supplied from the not-illustrated power source, to the coils of the respective phases 111 to 114, 121 to 124, and 131 to 134 via the U-phase terminal 19, the V-phase terminal 29, and the W-phase terminal 39 as the external terminals.

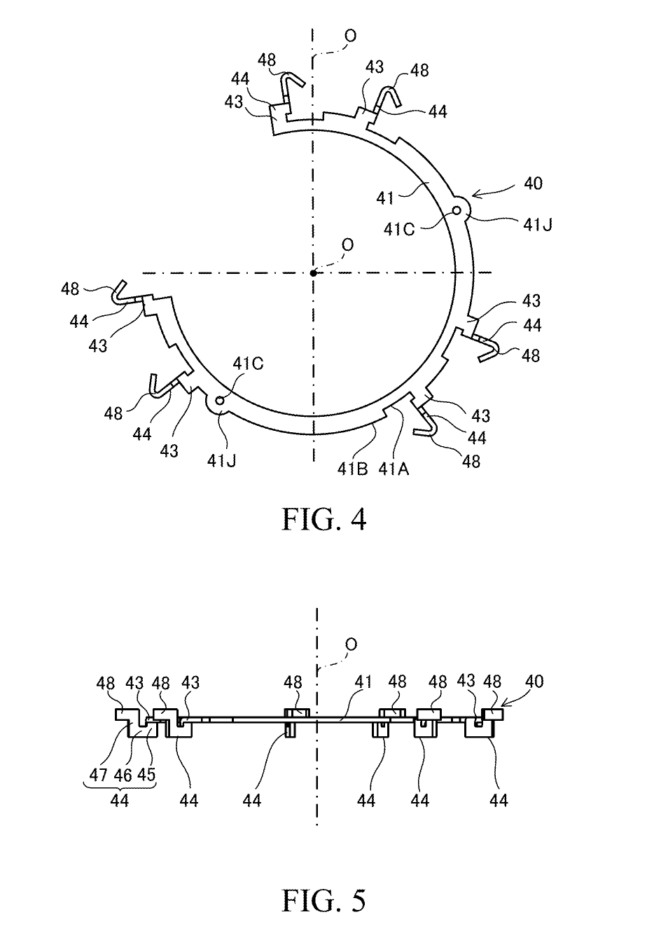

FIG. 4 is a front view of the second bus bar 40, and FIG. 5 is a side view of the second bus bar 40.

The main body part 41 of the second bus bar 40 has an arc shape, in which a part of an annular shape is missing, and extends from the position close to the third U-phase coil 113 to the position close to the third V-phase coil 123. The U-phase terminal 19, the V-phase terminal 29, and the W-phase terminal 39 are arranged at the part where the annular shape is missing in the main body part 41. Incidentally, this is not restrictive and the main body part 41 may have a perfect annular shape.

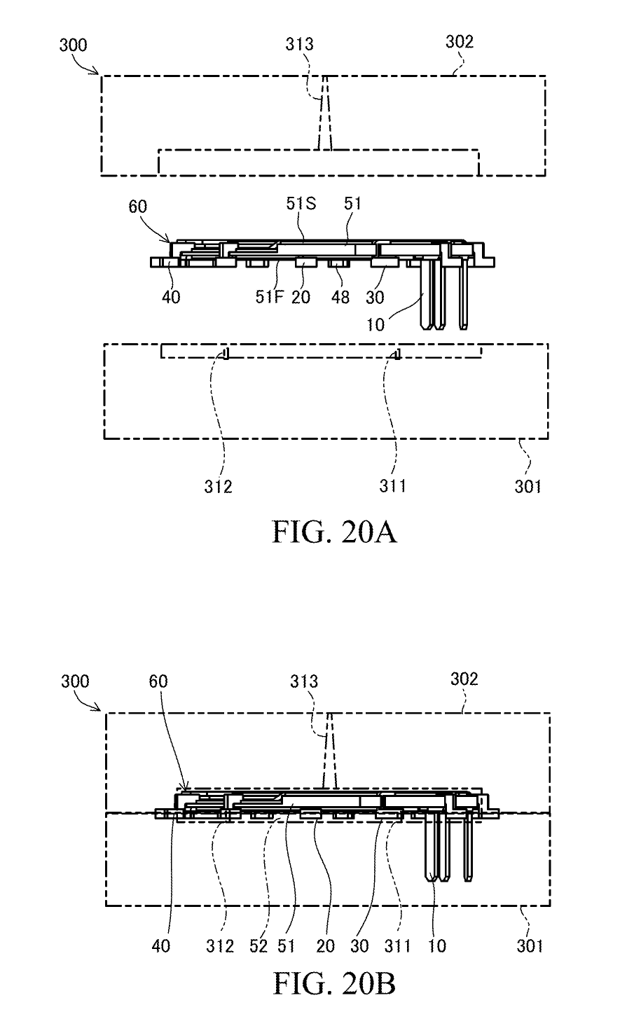

In the middle of the main body part 41, two positioning parts 41C are formed as holes penetrating the main body part 41. At the time of the later-described insert molding, support members (pins) 311 and 312 of a second mold 300 are inserted into the respective positioning parts 41C, so that the position of the second bus bar 40 is defined with respect to the second mold 300 (refer to FIG. 20A).

In the middle of the main body part 41, expansion parts 41J, each of which expands in an arc shape, are formed around the two positioning parts 41C. This causes the punching width of the main body part 41, at the portion including each of the expansion parts 41J, to be equal to or greater than the punching widths of other portions, so that the sufficient cross-sectional area of the conductive material can be secured.

Each extension part 44 of the second bus bar 40 is formed to have a band shape extending in a crank shape from each projection part 43, and is bent from the projection part 43 in the direction approaching the stator 100. The extension part 44 includes a first axial direction extension part 45 that extends in the axial direction (the direction approaching the stator 100), a radial direction extension part 46 that extends in the radial direction from the first axial direction extension part 45, and a second axial direction extension part 47 that is extended in the parallel direction to the first axial direction extension part 45 (the direction separating from the stator 100) from the end of the radial direction extension part 46 opposite to the first axial direction extension part 45.

At the time of bending work of each extension part 44, the extension part 44 that is clamped by a jig (not illustrated) is bent at right angles to each projection part 43 that is clamped by another jig (not illustrated).

In the main body part 41, an outer periphery 41A of a portion extending along each extension part 44 has the outer diameter that is smaller than that of an outer periphery 41B of the portion adjacent thereto, and thus a gap is formed between the extension part 44 and the outer periphery 41A of the main body part 41. This makes it possible to avoid interference between the jig that clamps the extension part 44 at the time of the bending work and the main body part 41.

The length in the axial direction of the second axial direction extension part 47 is set to be equal to the length in the axial direction of the first axial direction extension part 45. Thereby, each connection part 48 is arranged at the same position as the main body part 41 with respect to the axial direction.

The six connection parts 48 are arranged on the second bus bar 40 with predetermined intervals in the circumferential direction. Each connection part 48 is a portion projecting from the tip of the radial direction of the second axial direction extension part 47, and this portion is bent in a hook shape.

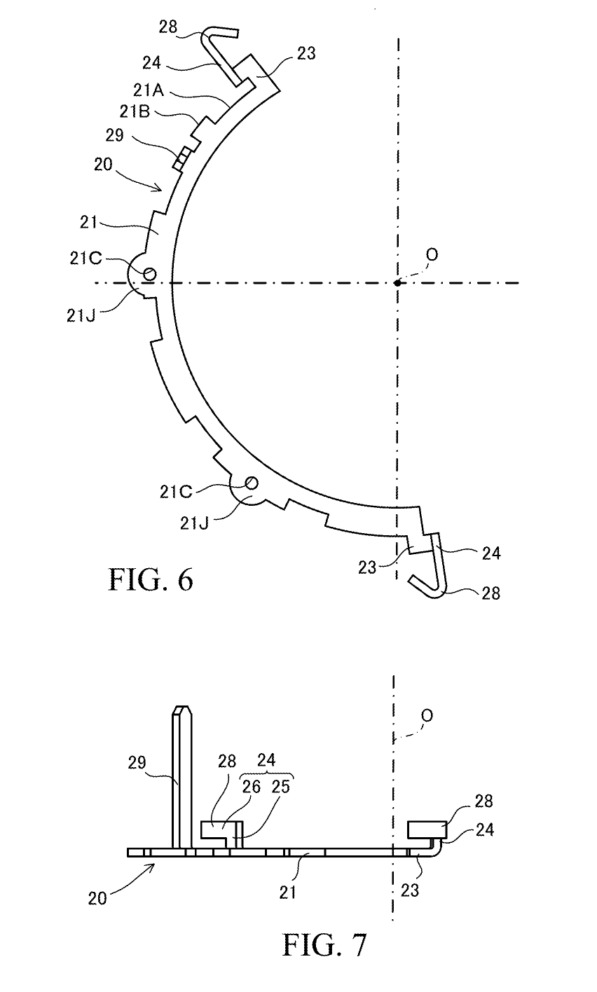

FIG. 6 is a front view of the first bus bar 20, and FIG. 7 is a side view of the first bus bar 20.

The main body part 21 of the first bus bar 20 has a semicircular arc shape, and extends from the position close to the first V-phase coil 121 to the position close to the fourth W-phase coil 134.

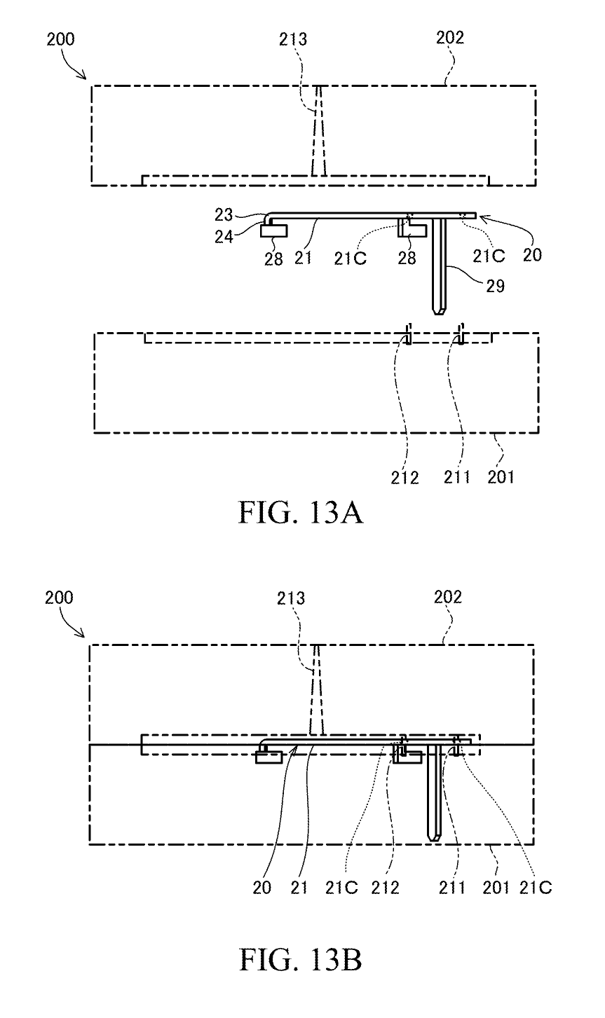

In the middle of the main body part 21, two positioning parts 21C are formed as holes penetrating the main body part 21. At the time of the later-described insert molding, support members (pins) 211 and 212 of a first mold 200 are inserted into the respective positioning parts 21C, so that the position of the first bus bar 20 is defined with respect to the first mold 200 (refer to FIG. 13A).

In the middle of the main body part 21, expansion parts 21J, each of which expands in an arc shape, are formed around the two positioning parts 21C. This causes the punching width of the main body part 21, at the portion including each of the expansion parts 21J, to be equal to or greater than the punching widths of other portions, so that the sufficient cross-sectional area of the conductive material can be secured.

Each extension part 24 of the first bus bar 20 is formed to have a band shape extending in a crank shape from each projection part 23, and is provided with a first axial direction extension part 25 that extends in the axial direction (the direction separating from the stator 100), and a radial direction extension part 26 that extends in the radial direction from the first axial direction extension part 25.

In the first bus bar 20, an outer periphery 21A of the main body part 21 that extends along each extension part 24 has the outer diameter that is smaller than that of an outer periphery 21B adjacent thereto, and thus a gap is formed between the extension part 24 and the outer periphery 21A of the main body part 21. This makes it possible to avoid the interference between the jig that clamps the extension part 24 at the time of the bending work and the main body part 21.

As each extension part 24 is bent from the projection part 23 in the direction separating from the stator 100, each connection part 28 is offset from the main body part 21 in the direction separating from the stator 100 in the axial direction. When the dimension of the first axial direction extension part 25 is set appropriately, the connection part 28 is arranged at the same position as each connection part 48 of the second bus bar 40 with respect to the axial direction. When the dimension of the radial direction extension part 26 is set appropriately, the connection part 28 is arranged at the same position as each connection part 48 of the second bus bar 40 with respect to the radial direction.

The two connection parts 28 are arranged at both ends of the first bus bar 20. Each connection part 28 is a portion projecting from the tip of the radial direction of the radial direction extension part 26, and this portion is bend in a hook shape.

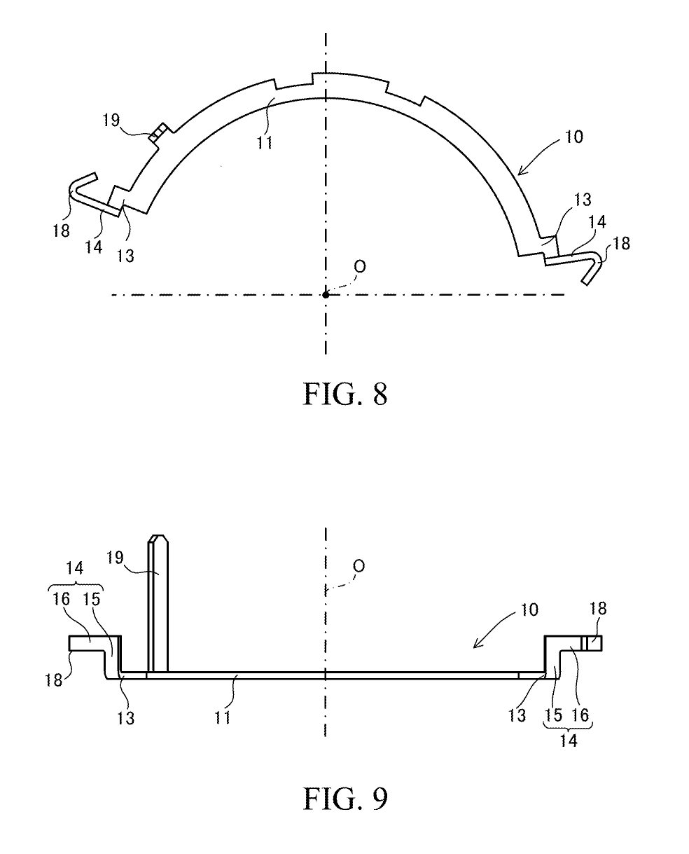

FIG. 8 is a front view of the fourth bus bar 10, and FIG. 9 is a side view of the fourth bus bar 10.

The main body part 11 of the fourth bus bar 10 has a semicircular arc shape, and extends from the position close to the fourth U-phase coil 114 to the position close to the first U-phase coil 111.

Each extension part 14 of the fourth bus bar 10 is formed to have a band shape extending in a crank shape from each projection part 13, and is provided with a first axial direction extension part 15 that extends in the axial direction (the direction separating from the stator 100), and a radial direction extension part 16 that extends in the radial direction from the first axial direction extension part 15.

As each extension part 14 is bent from each projection part 13 in the direction separating from the stator 100, each connection part 18 is offset from the main body part 11 in the direction separating from the stator 100 in the axial direction. When the dimension of the first axial direction extension part 15 is set appropriately, the connection part 18 is arranged at the same position as each connection part 48 of the second bus bar 40 with respect to the axial direction. When the dimension of the radial direction extension part 16 is set appropriately, the connection part 18 is arranged at the same position as each connection part 48 of the second bus bar 40 with respect to the radial direction.

The two connection parts 18 are arranged at both ends of the main body part 11. Each connection part 18 is a portion projecting from the tip of the radial direction of the radial direction extension part 16, and this portion is bend in a hook shape.

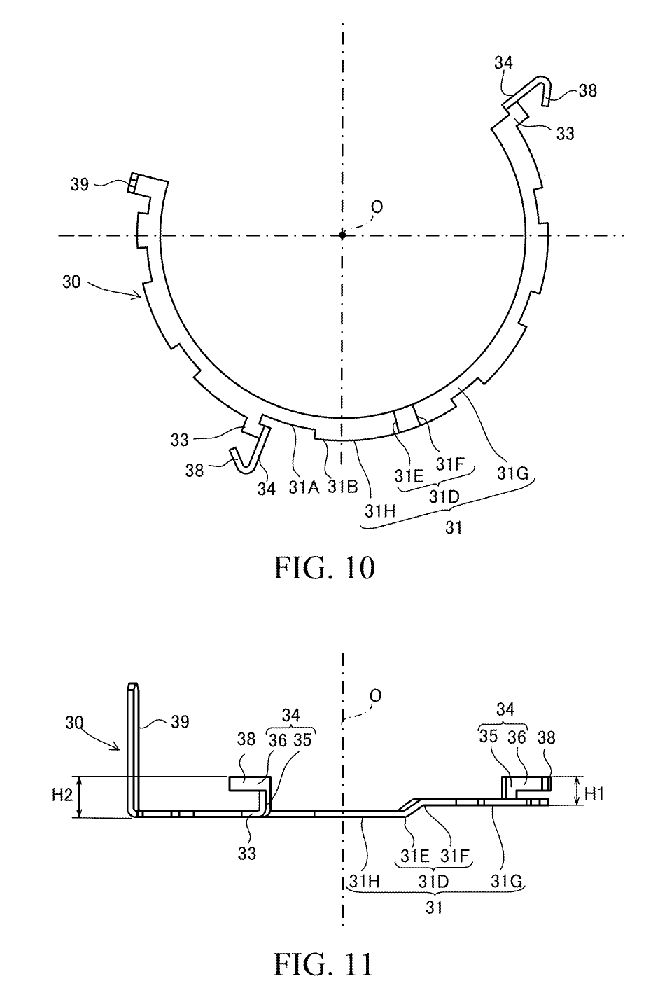

FIG. 10 is a front view of the third bus bar 30, and FIG. 11 is a side view of the third bus bar 30.

The main body part 31 of the third bus bar 30 has an arc shape, in which a part thereof is missing, and extends from the position close to the fourth U-phase coil 114 to the position close to the fourth W-phase coil 134.

A bent main body part 31D is formed in the middle of the main body part 31. The bent main body part 31D includes two bent parts 31E and 31F that are bent along lines extending in the radial direction, and its cross section bends to have a crank shape.

A first main body part 31G that has an arc shape and that extends in the circumferential direction (counterclockwise direction in FIG. 10) from the bent main body part 31D, and a second main body part 31H that has an arc shape and that extends in the circumferential direction (clockwise direction in FIG. 10) from the bent main body part 31D are formed in the main body part 31.

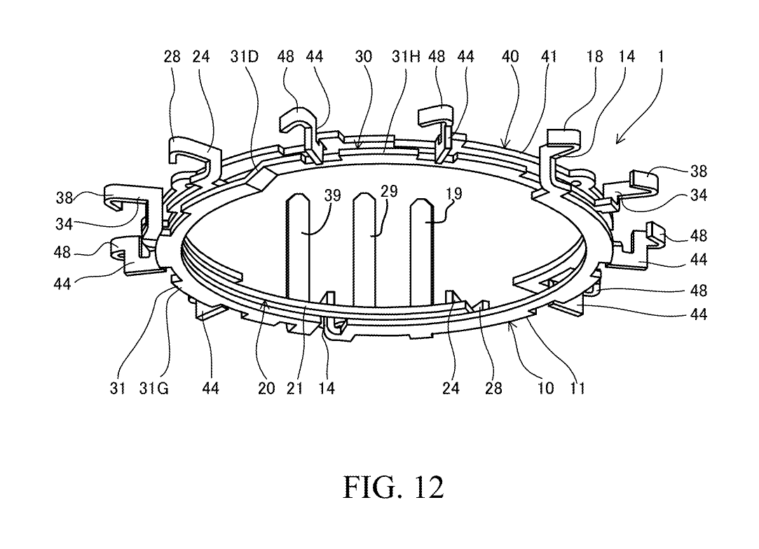

The first main body part 31G is arranged next to the fourth bus bar 10 along the circumferential direction, at a first stacked position that will be described later (refer to FIG. 12). One connection part 38 is arranged at the tip of the first main body part 31G.

The second main body part 31H is arranged next to the first bus bar 20 along the circumferential direction, at a second stacked position that will be described later (refer to FIG. 12). One connection part 38 is arranged in the middle of the second main body part 31H, and the W-phase terminal 39 is arranged at the tip of the second main body part 31H.

Each of the two extension parts 34 includes a first axial direction extension part 35 that extends in the axial direction (the direction separating from the stator 100) and that is formed to have a band shape extending in a crank shape from the projection part 33, and a radial direction extension part 36 that extends in the radial direction from the first axial direction extension part 35.

In the second main body part 31H, an outer periphery 31A of a portion extending along each extension part 34 has the outer diameter that is smaller than that of an outer periphery 31B of the portion adjacent thereto, and thus a gap is formed between the extension part 34 and the outer periphery 31A of the main body part 31. This makes it possible to avoid the interference between the jig that clamps the extension part 34 at the time of the bending work and the main body part 31.

As each extension part 34 is bent from each projection part 33 in the direction separating from the stator 100, each connection part 38 is offset from the main body part 31 in the direction separating from the stator 100.

A dimension H1 in the axial direction of the first axial direction extension part 35 that is provided on the first main body part 31G is set to be smaller than a dimension H2 of the first axial direction extension part 35 that is provided on the second main body part 31H. A difference between the dimensions (H2-H1) is set to be equal to the length between the first stacked position and the second stacked position separating in the axial direction. Thereby, the connection part 38 that is provided on the first main body part 31G and the connection part 38 that is provided on the second main body part 31H are arranged at the same positions with respect to the axial direction. Therefore, the respective connection parts 38 are arranged at the same positions as the connection parts 48 of the second bus bar 40, with respect to the axial direction.

Each connection part 38 is a portion projecting from the tip of the radial direction of the radial direction extension part 36, and this portion is bent in a hook shape.

When the dimension of the radial direction extension part 36 is set appropriately, each connection part 38 is arranged at the same position as each connection part 48 of the second bus bar 40 with respect to the radial direction.

Incidentally, the shapes of the connection parts 28, 48, 38, and 18 are not limited to those bent in the hook shapes, as described above, and may have other shapes.

FIG. 12 is a perspective view in which the first to fourth bus bars 20, 40, 30, and 10 are assembled at the respective stacked positions, without illustrating the insulating resin body 50.

The bus bar unit 1 has the first stacked position, the second stacked position, and a third stacked position that are separated in this order from the stator 100, along the axial direction. At the first stacked position that is closest to the stator 100, the main body part 11 of the fourth bus bar 10 is arranged. At the second stacked position that is next closest to the stator 100, the main body part 21 of the first bus bar 20 is arranged. The main body part 31 of the third bus bar 30 is arranged across the first stacked position and the second stacked position. At the third stacked position that is farthest from the stator 100, the main body part 41 of the second bus bar 40 is arranged.

The bent main body part 31D of the third bus bar 30, which is bent in a crank shape, is arranged across the first stacked position and the second stacked position.

At the first stacked position, the first main body part 31G, extending in the arc shape from the bent main body part 31D, is arranged next to the main body part 11 of the fourth bus bar 10 along the circumferential direction. As the first main body part 31G is separated in the circumferential direction from the main body part 11 of the fourth bus bar 10, the first main body part 31G and the main body part 11 of the fourth bus bar 10 are kept insulated.

A part of the first main body part 31G is arranged so as to overlap the main body part 21 of the first bus bar 20. As the first main body part 31G is separated in the axial direction from the main body part 21 of the first bus bar 20, the first main body part 31G and the main body part 21 of the first bus bar 20 are kept insulated.

At the second stacked position, the second main body part 31H, extending in the arc shape from the bent main body part 31D, is arranged next to the main body part 21 of the first bus bar 20 along the circumferential direction. As the second main body part 31H is separated in the circumferential direction from the main body part 21 of the first bus bar 20, the second main body part 31H and the main body part 21 of the first bus bar 20 are kept insulated.

A part of the second main body part 31H is arranged so as to overlap the main body part 11 of the fourth bus bar 10. As the second main body part 31H is separated in the axial direction from the main body part 11 of the fourth bus bar 10, the second main body part 31H and the main body part 11 of the fourth bus bar 10 are kept insulated.

With regard to the main body part 31 of the third bus bar 30, the first main body part 31G is arranged at the first stacked position together with the main body part 11 of the fourth bus bar 10, and the second main body part 31H is arranged at the second stacked position together with the main body part 21 of the first bus bar 20. This makes it possible to reduce the axial dimension of the bus bar unit 1 as compared with the one in which the stacked position where the main body part 31 of the third bus bar 30 is arranged is provided independently.

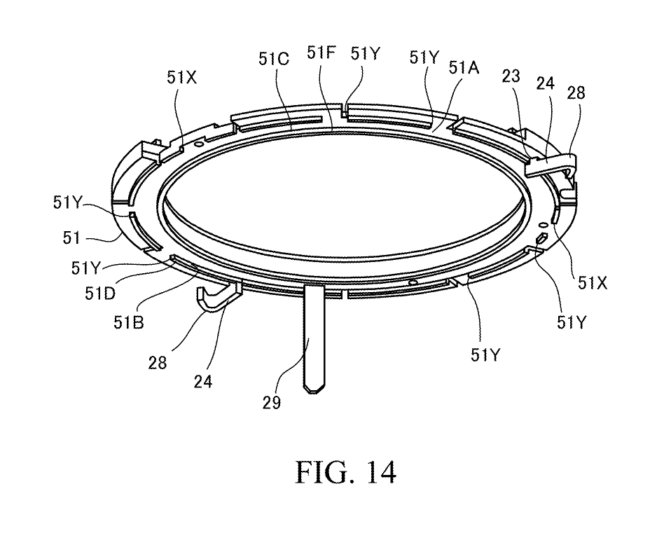

Next, the step of molding the bus bar unit 1 by the insert molding will be explained. The bus bar unit 1 is manufactured by executing respective steps of a primary setting step (FIG. 13A) that disposes the first bus bar 20 into the first mold 200, a primary molding step (FIG. 13B) that injects an insulating resin material into the first mold 200 and molds a primary molded member 60 (FIG. 14 to FIG. 16) by the insert molding, a secondary setting step (FIG. 20A) that stacks and disposes the fourth bus bar 10, the primary molded member 60, the third bus bar 30 and the second bus bar 40 into the second mold 300 in the state so that the primary molded member 60 is sandwiched between the fourth and third bus bars 10, 30 and the second bus bar 40, and a secondary molding step (FIG. 20B) that injects the insulating resin material into the second mold 300 and molds the bus bar unit 1 (secondary molded member) by the insert molding.

FIG. 13A is a schematic view for explaining the primary setting step. The first mold 200 is provided with a first lower mold 201 that is arranged on the lower side in the vertical direction, and a first upper mold 202 that is arranged on the upper side. Inside the first lower mold 201, the two support members 211 and 212 are provided to project upwardly. The two support members 211 and 212 are columnar pins. Incidentally, not only the pin having the circular cross section, but only a pin having a noncircular cross section may be employed as the support members 211 and 212.

In the primary setting step, the two support members 211 and 212 are inserted into the positioning parts 21C of the first bus bar 20, at the time when the first bus bar 20 is set in the first lower mold 201, so that the position of the first bus bar 20 is defined with respect to the first mold 200.

After the first bus bar 20 is set in the first lower mold 201, the first upper mold 202 is closed onto the first lower mold 201.

FIG. 13B is a schematic view for explaining the primary molding step. In the primary molding step, the pressurized insulating resin material is injected from an injection hole 213 that is provided in the first upper mold 202. At this time, as the first bus bar 20 is supported by the two support members 211 and 212 that are inserted into the positioning parts 21C, deformation and displacement, due to an injection pressure of the insulating resin material, can be prevented.

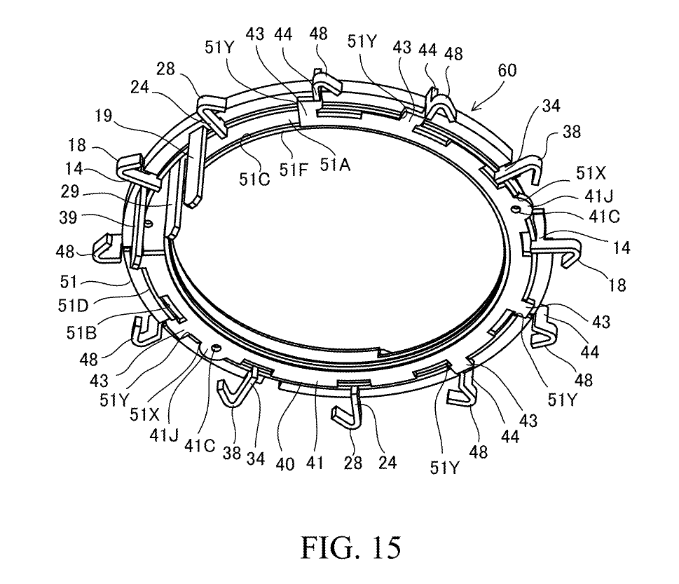

A primary insulating resin body 51, as the cured insulating resin material injected into the first mold 200, is integrated with the first bus bar 20, so as to form the primary molded member 60 (FIG. 14 and FIG. 15). Thereafter, the primary molded member 60 is removed from the first mold 200. The primary molded member 60 is formed by the first bus bar 20 and the primary insulating resin body 51.

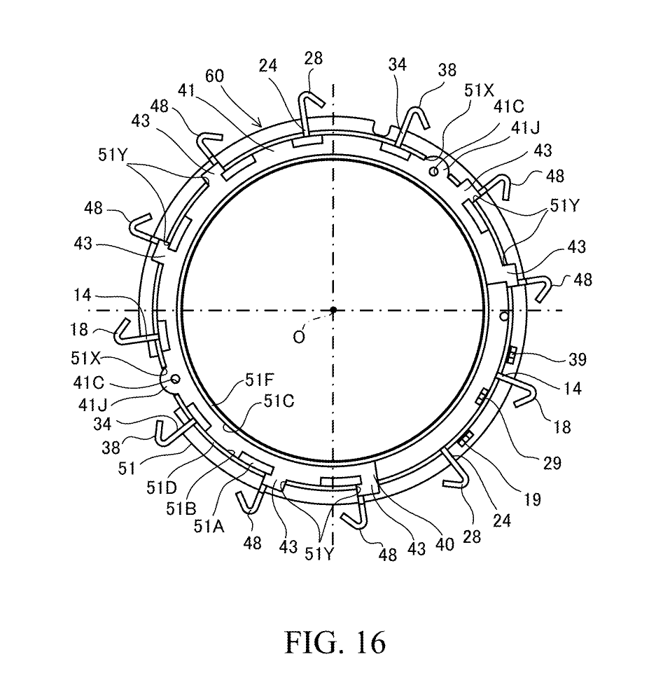

FIG. 14 is a perspective view of the primary molded member 60 as a single unit viewed from the forward direction. FIG. 15 to FIG. 16 illustrate the state in which the second bus bar 40, the third bus bar 30, and the fourth bus bar 10 are assembled to the primary molded member 60. FIG. 15 is a perspective view of the primary molded member 60 viewed from the forward direction, and FIG. 16 is a front view.

As illustrated in FIG. 14, the primary insulating resin body 51 of the primary molded member 60 has a disk shape. The primary molded member 60 has, on its forward side, a first ring-shaped abutting surface 51A against which the main body part 41 of the second bus bar 40 abuts, an outer rib 51D that projects along the outer periphery of the first abutting surface 51A, and an inner rib 51F that projects along the inner periphery of the first abutting surface 51A.

As illustrated in FIG. 15 and FIG. 16, the first abutting surface 51A is formed as a ring-shaped plane surface along the main body part 41 of the second bus bar 40.

The outer rib 51D has a first step part 51B on its inner periphery. The first step part 51B abuts against the outer periphery of the main body part 41 of the second bus bar 40. The first step part 51B has a notched part 51X, with which the expansion part 41J of the second bus bar 40 engages, and a notched part 51Y, with which the projection part 43 engages. Thereby, the position of second bus bar 40 in the circumferential direction is defined with respect to the primary molded member 60.

The inner rib 51F has a second step part 51C on its outer periphery. The second step part 51C abuts against the inner periphery of the main body part 41 of the second bus bar 40.

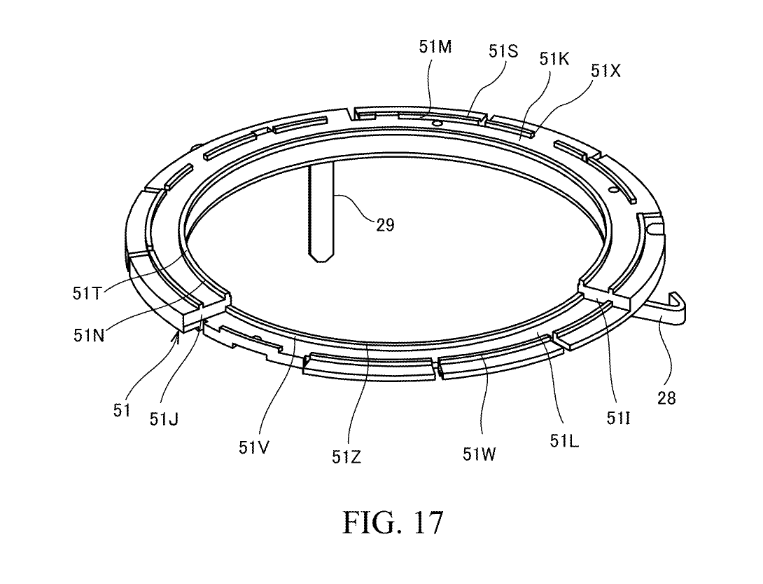

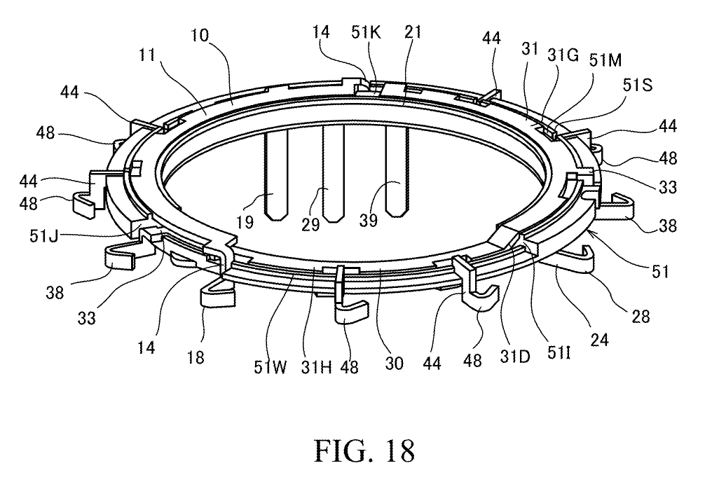

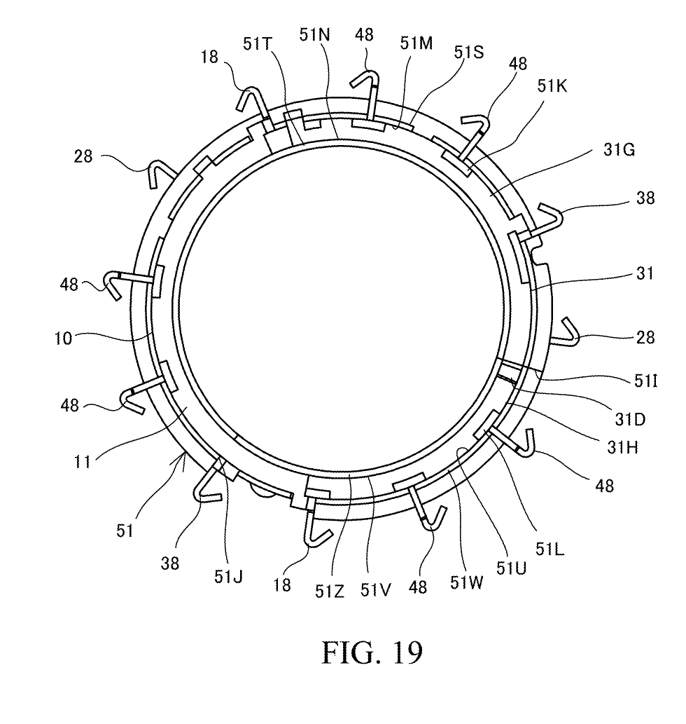

FIG. 17 is a perspective view of the primary molded member 60 as a single unit viewed from the backward direction. FIG. 18 and FIG. 20 are schematic views illustrating the state in which the second bus bar 40, the third bus bar 30, and the fourth bus bar 10 are assembled to the primary molded member 60. FIG. 18 is a perspective view of the primary molded member 60 viewed from the backward direction, and FIG. 19 is a rear view.

As illustrated in FIG. 17, the primary molded member 60 has, on its backward side, a second abutting surface 51K against which the main body part 11 of the fourth bus bar 10 and the first main body part 31G of the third bus bar 30 abuts, and a third abutting surface 51L against which the second main body part 31H of the third bus bar 30 abuts. Between the second abutting surface 51K and the third abutting surface 51L, a step part 51I and a step part 51J are formed in the axial direction.

As illustrated in FIG. 18 and FIG. 19, the second abutting surface 51K is formed as an arc-shaped plane surface along the main body part 11 of the fourth bus bar 10 and the first main body part 31G of the third bus bar 30.

The primary molded member 60 has an outer rib 51S that projects along the outer periphery of the second abutting surface 51K, and an inner rib 51T that projects along the inner periphery of the second abutting surface 51K.

The outer rib 51S has a third step part 51M on its inner periphery. The third step part 51M abuts against the outer periphery of the main body part 11 of the fourth bus bar 10 and the outer periphery of the first main body part 31G of the third bus bar 30. Portions, with which the projection parts 13 and 33, the extension parts 24 and 44 and the like engage, are cut out from the third step part 51M.

The inner rib 51T has a fourth step part 51N on its outer periphery. The fourth step part 51N abuts against the inner periphery of the main body part 11 of the fourth bus bar 10 and the inner periphery of the first main body part 31G of the third bus bar 30.

The third abutting surface 51L is formed as an arc-shaped plane surface along the second main body part 31H of the third bus bar 30.

The primary molded member 60 has, on its backward side, an outer rib 51W that projects along the outer periphery of the third abutting surface 51L, and an inner rib 51Z that projects along the inner periphery of the third abutting surface 51L.

The outer rib 51W has a fifth step part 51U on its inner periphery. The fifth step part 51U abuts against the outer periphery of the second main body part 31H of the third bus bar 30. Portions, with which the projection parts 33, the extension parts 14 and 44 and the like engage, are cut out from the fifth step part 51U.

The inner rib 51Z has a sixth step part 51V on its outer periphery. The sixth step part 51V abuts against the inner periphery of the second main body part 31H of the third bus bar 30.

The third step part 51M and the fifth step part 51U extend on the same circumference as illustrated in FIG. 19, but have a difference in level in the axial direction. Similarly, the fourth step part 51N and the sixth step part 51V extend on the same circumference, but have a difference in level in the axial direction.

FIG. 20A is a schematic view for explaining the secondary setting step. The second mold 300 is provided with a second lower mold 301 that is arranged on the lower side in the vertical direction, and a second upper mold 302 that is arranged on the upper side. Inside the second lower mold 301, the two support members 311 and 312 are provided to project upwardly. The support members 311 and 312 are columnar pins. Incidentally, not only the pin having the circular cross section, but only a pin having a noncircular cross section may be employed as the support members 311 and 312.

In the second setting step, the two support members 311 and 312 are inserted into the positioning parts 41C of the second bus bar 40, at the time when the second bus bar 40 is set in the second lower mold 301, so that the position of the second bus bar 40 is defined with respect to the second mold 300.

In the second setting step, the second bus bar 40 is set at a predetermined position and then, the primary molded member 60 is placed on the second bus bar 40, and the third bus bar 30 and the fourth bus bar 10 are placed on the primary molded member 60. The third bus bar 30 is arranged next to the fourth bus bar 10 along the circumferential direction as the first main body part 31G abuts against the second abutting surface 51K of the primary molded member 60, and is arranged next to the first bus bar 20 in the primary molded member 60 along the circumferential direction as the second main body part 31H abuts against the third abutting surface 51L of the primary molded member 60. The tip end of the second main body part 31H of the third bus bar 30 and the main body part 11 of the fourth bus bar 10 are arranged to overlap one another with a space therebetween in the axial direction.

Thus, after the second bus bar 40, the primary molded member 60, the third bus bar 30, and the fourth bus bar 10 are stacked in this order on the second lower mold 301, the second upper mold 302 is closed onto the second lower mold 301.

FIG. 20B is a schematic view for explaining the secondary molding step. In the second molding step, the pressurized insulating resin material is injected from an injection hole 313 that is provided in the second upper mold 302.

In the second molding step, the second bus bar 40 is arranged in such a manner that the two support members 311 and 312 are fitted into the positioning parts 41C, the outer periphery and the inner periphery of the main body part 41 abut against the first step part 51B and the second step part 51C, and the outer periphery of the main body part 41 abuts against the first step part 51B. Thereby, the deformation and the displacement of the second bus bar 40, due to the injection pressure of the insulating resin material, can be prevented.

Incidentally, when the direction, to which the second bus bar 40 is biased, is limited due to the injection pressure of the insulating resin material, either one of the first step part 51B and the second step part 51C may be omitted.

With the third bus bar 30, the outer periphery and the inner periphery of the first main body part 31G abut against the third step part 51M and the fourth step part 51N of the primary molded member 60, and the outer periphery and the inner periphery of the second main body part 31H abut against the fifth step part 51U and the sixth step part 51V of the primary molded member 60. Thereby, the deformation of the third bus bar 30, due to the injection pressure of the insulating resin material, can be prevented.

With the fourth bus bar 10, the outer periphery and the inner periphery of the main body part 11 abut against the third step part 51M and the fourth step part 51N of the primary molded member 60, thereby, the deformation, due to the injection pressure of the insulating resin material, can be prevented.

Incidentally, when the direction, to which the third bus bar 30 and the fourth bus bar 10 are biased, is limited due to the injection pressure of the insulating resin material, either one of the third step part 51M and the fourth step part 51N, and either one of the fifth step part 51U and the sixth step part 51V may be omitted.

When the insulating resin material that is injected into the second mold 300 is cured, a secondary insulating resin body 52, integrated with the second bus bar 40, the primary molded member 60, the third bus bar 30, and the fourth bus bar 10, is formed (refer to FIG. 2). The insulating resin body 50 of the bus bar unit 1 is formed by the primary insulating resin body 51 that is formed in the primary molding step, and the secondary insulating resin body 52 that is formed around the primary insulating resin body 51 in the secondary molding step. Thereafter, the secondary insulating resin body 52 is removed from the second mold 300. Thus, the bus bar unit 1 as illustrated in FIG. 2 is manufactured.

The following effects can be obtained according to the above-described embodiment.

The manufacturing method of the bus bar unit 1 for performing the insert molding of the plurality of bus bars 10, 20, 30, and 40 by using the insulating resin material includes: the primary setting step of disposing the first bus bar 20 into the first mold 200; the primary molding step of performing the insert molding by injecting the insulating resin material into the first mold 200, so as to form the primary molded member 60 having the first step part 51B and the second step part 51C; the secondary setting step of stacking and disposing the primary molded member 60 and the remaining second bus bar 40, the third bus bar 30, and the fourth bus bar 10 into the second mold 300; and the secondary molding step of performing the insert molding by injecting the insulating resin material into the second mold 300, so as to form the bus bar unit 1. In the secondary setting step, the second bus bar 40 is arranged in such a manner that the positioning parts 41C of the second bus bar 40 are fitted into the support members 311 and 312 of the second mold 300, and the primary molded member 60 is arranged in such a manner that at least either one of the outer periphery and the inner periphery of the second bus bar 40 abuts against the first step part 51B or the second step part 51C of the primary molded member 60.

Thus, as the support members 311 and 312 are fitted with the positioning parts 41C of the second bus bar 40 in the secondary setting step, the positions of the second bus bar 40 and the primary molded member 60 are defined more certainly with respect to the second mold 300, and the displacement of the second bus bar 40, due to the pressure of the insulating resin material injected into the second mold 300, is avoided as the outer periphery and the inner periphery of the second bus bar 40 abuts against the first step part 51B and the second step part 51C of the primary molded member 60. Thereby, positional accuracy of the second bus bar 40 in the bus bar unit 1 can be secured.

The primary molded member 60 has, on its one end surface, the first step part 51B and the second step part 51C, against which at least one of the outer periphery and the inner periphery of the second bus bar 40 abuts, and has, on its another end surface, the third step part 51M, the fourth step part 51N, the fifth step part 51U, and the sixth step part 51V, against which at least one of the outer periphery and the inner periphery of the third bus bar 30 abuts.

In the secondary molding step, the outer peripheries and the inner peripheries of the first main body part 31G and the second main body part 31H, which are offset in the axial direction due to the pressure of the insulating resin material injected into the second mold 300, abut against the third step part 51M, the fourth step part 51N, the fifth step part 51U, and the sixth step part 51V formed on the primary molded member 60, so that the displacement of the third bus bar 30 is avoided. Thereby, the positional accuracy of the third bus bar 30 in the bus bar unit 1 can be secured.

In the secondary molding step, the outer peripheries of the first main body part 31G and the second main body part 31H, which are offset in the axial direction due to the injection pressure of the insulating resin material injected into the second mold 300, abut against the third step part 51M, and the fifth step part 51U formed on the primary molded member 60, so that the displacement of the third bus bar 30 is avoided. Similarly, the inner peripheries of the first main body part 31G and the second main body part 31H, which are offset in the axial direction due to the injection pressure of the insulating resin material injected into the second mold 300, abut against the fourth step part 51N and the sixth step part 51V formed on the primary molded member 60, so that the displacement of the third bus bar 30 is avoided. Thereby, the positional accuracy of the third bus bar 30 in the bus bar unit 1 can be secured.

As the first step part 51B of the outer rib 51D has the notched parts 51X and 51Y that engage with the expansion part 41J and the projection part 43 projecting from the outer periphery of the second bus bar 40, the position of second bus bar 40 in the circumferential direction is defined with respect to the primary molded member 60.

It should be noted that this is not restrictive, and a portion that projects from the inner periphery of the second bus bar 40 may be formed and engaged with a notched part formed on the fourth step part 51N of the inner rib 51T.

Embodiments of this invention were described above, but the above embodiments are merely examples of applications of this invention, and the technical scope of this invention is not limited to the specific constitutions of the above embodiments.

According to the above-described embodiment, for example, the positioning parts 41C and 21C are formed as the holes penetrating the main body parts 41 and 21. However, the positioning parts 41C and 21C may be formed by cutting a part of the main body parts 41 and 21, or by recessing a part of the main body parts 41 and 21.

Further, according to the above-described embodiment, the two coils corresponding to the respective phases are arranged opposingly, and the coils 111 to 114, 121 to 124, and 131 to 134 of the respective phases are allowed to have the two series/two parallel connection. However, three or more coils may be arranged opposingly. Namely, three series/two parallel connection is made when three coils are arranged opposingly, and four series/two parallel connection is made when four coils are arranged opposingly.

Furthermore, according to the above-described embodiment, the three phase AC motor having the twelve coils 111 to 114, 121 to 124, and 131 to 134 is explained as an example, but the number of the coils is not restrictive. Each of the first to third bus bars may be provided in a plural number as the number of the coils provided in the stator increases.

Further, according to the above-described embodiment, the first to fourth bus bars 20, 40, 30, and 10 are disposed in the bus bar unit 1 in the order of the fourth bus bar 10, the first bus bar 20, the third bus bar 30, and the second bus bar 40, but may be disposed according to other orders.

Furthermore, according to the above-described embodiment, the case of providing the four kinds of the bus bars 10, 20, 30, and 40 is explained as an example, but the bus bars of three kinds or less or five kinds or more may be provided according to the type of the motor.

Further, according to the above-described embodiment, the bus bar unit corresponding to the stator in star connection, in which one ends of the coils of the respective phases are connected via the neutral point, is explained as an example, but a bus bar unit may correspond to a stator in delta connection. In this case, the bus bar unit is not provided with the bus bar for the neutral point.

Furthermore, according to the above-described embodiment, the case of connecting the bus bar unit 1 to the motor that generates motive power by electric power is explained as an example, but may be applied to a generator that generates electric power by motive power.

This application claims priority based on Japanese Patent Application No. 2013-047245 filed with the Japan Patent Office on Mar. 8, 2013, the entire contents of which are incorporated into this specification.

1. A manufacturing method of a bus bar unit for performing insert molding of a plurality of bus bars by using an insulating resin material, the manufacturing method of the bas bar comprising:
a primary setting step of disposing a part of the plurality of bus bars into a first mold;
a primary molding step of performing the insert molding by injecting the insulating resin material into the first mold, so as to form a primary molded member having a step part;
a secondary setting step of stacking and disposing the primary molded member and a remaining bus bar of the plurality of bus bars into a second mold; and
a secondary molding step of performing the insert molding by injecting the insulating resin material into the second mold, so as to form the bus bar unit,
wherein, in the secondary setting step, the primary molded member and the remaining bus bar of the plurality of bus bars are arranged in the second mold in such a manner that at least one of an outer periphery and an inner periphery of the remaining bus bar abuts against the step part of the primary molded member.

2. The manufacturing method of the bus bar unit according to claim 1,
wherein the bus bar unit comprises a first bus bar, a second bus bar, and a third bus bar that electrically connect coils corresponding to respective phases of a stator,
in the primary setting step, the first bus bar is disposed into the first mold,
in the primary molding step, the primary molded member is formed by the insert molding of the first bus bar
in the secondary setting step, the second bus bar, the primary molded member, and the third bus bar are stacked in this order, and the second bus bar is arranged in such a manner that a positioning part of the second bus bar is fitted with a support member of the second mold, and at least one of an outer periphery and an inner periphery of the second bus bar abuts against the step part formed on the primary molded member.

3. The manufacturing method of the bus bar unit according to claim 2,
wherein the primary molded member has, on its one end surface, the step part against which at least one of the outer periphery and the inner periphery of the second bus bar abuts, and has, on its another end surface, the step part against which at least one of an outer periphery and an inner periphery of the third bus bar abuts.

4. The manufacturing method of the bus bar unit according to claim 1,
wherein the step part has a notched part that engages with a portion that projects from the outer periphery or the inner periphery of each of the bus bars.
